(19) United States
(12) Patent Application Publication
(10) Pub. No.: US 2021/0297813 A1
(43) Pub. Date: Sep. 23, 2021

(54) LOCKING EARRING TRACKING DEVICE WITH REMOTE

(71) Applicant: Ann Imrie Camp, Pleasanton, CA (US)

(72) Inventor: Ann Imrie Camp, Pleasanton, CA (US)

(21) Appl. No.: 16/823,276

(22) Filed: Mar. 18, 2020

(51) Int. Cl. H04W 4/029; A44C 7/00

(52) U.S. Cl. CPC H04W 4/029; A44C 7/00

(57) ABSTRACT

An illustrated view of a personal tracking system for tracking the location of a person is presented. The personal tracking device utilizes a remote control communicatively coupled to an earring featuring a GPS transceiver for determining location of the person. The personal tracking system cannot be easily removed, lost or stolen. The personal tracking system can be worn at all times, in bed, in the shower, jogging, playing, working, etc. The personal tracking device can be locked and unlocked remotely. The personal tracking system is useful for unlimited search areas and immediate response. Further, the personal tracking system is useful in bringing peace and mind to parents, care-givers and loved ones. Also, the personal tracking system can be easily moved from one location to another location while not being detected by others.

### FIELD OF THE INVENTION

This invention relates to tracking devices. More particularly, it relates to tracking devices in an earring.

### BACKGROUND

A GPS tracking unit, or personal tracking system, is a navigation device normally carried by a moving vehicle or person or animal that uses the Global Positioning System (GPS) to track the device's movements and determine its location. The recorded location data can either be stored within the tracking unit or transmitted to an Internet-connected device using the cellular (GPRS, UMTS, 4G, 5G or SMS), radio, or satellite modem embedded in the unit. This allows the location to be displayed against a map backdrop either in real time or when analyzing the track later, using GPS tracking software. Data tracking software is available for smartphones with GPS capability.

GPS personal tracking devices are used in the care of the elderly and vulnerable, and can be used to track small children who may get into danger. Some devices can send text alerts to caretakers if the wearer moves into an unexpected place. Some devices allow users to call for assistance, and optionally allow designated caretakers to locate the user's position, typically within five to ten meters. Their use helps promote independent living and social inclusion for the elderly. Devices often incorporate either one-way or two-way voice communication. Some devices also allow the user to call several phone numbers using pre-programmed speed dial buttons. Trials using GPS personal tracking devices for sufferers of early-stage dementia are underway in several countries. Text and voice communication are usually provided by a connection to mobile telephony, but GPS devices are available that use satellite communications, always available even if out of mobile telephone range.

An earring is a piece of jewelry attached to the ear via a piercing in the earlobe or another external part of the ear (except in the case of clip earrings, which clip onto the lobe). Earrings are worn by both sexes, although more common among women, and have been used by different civilizations in different times.

Locations for piercings other than the earlobe include the rook, tragus, and across the helix. The simple term “ear piercing” usually refers to an earlobe piercing, whereas piercings in the upper part of the external ear are often referred to as “cartilage piercings”. Cartilage piercings are more complex to perform than earlobe piercings and take longer to heal.

Many people can benefit from having a personal tracking device as the world becomes more violent and crime rises. These people often forget to take the personal tracking device with them or, in the case of young children, their parents either forget the personal tracking device or it is too bulky for the child. This may cause a problem in finding a person or child when they are lost or have been taken.

In light of the foregoing, it would be desirable to devise an earring that has a tracking device and a locking device such that when worn by a person or child that when the person or child is lost or has been abducted that the person or child can be tracked without others having knowledge the tracking device is on the person or child. Further, it would be desirable for the earring to be locked and unlocked by a remote device to prevent the earring from being taken off of the person or child by an abductor or the person or child.

### BRIEF DESCRIPTION OF THE DRAWINGS

FIG. 1 is an illustrated view of a personal tracking system.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

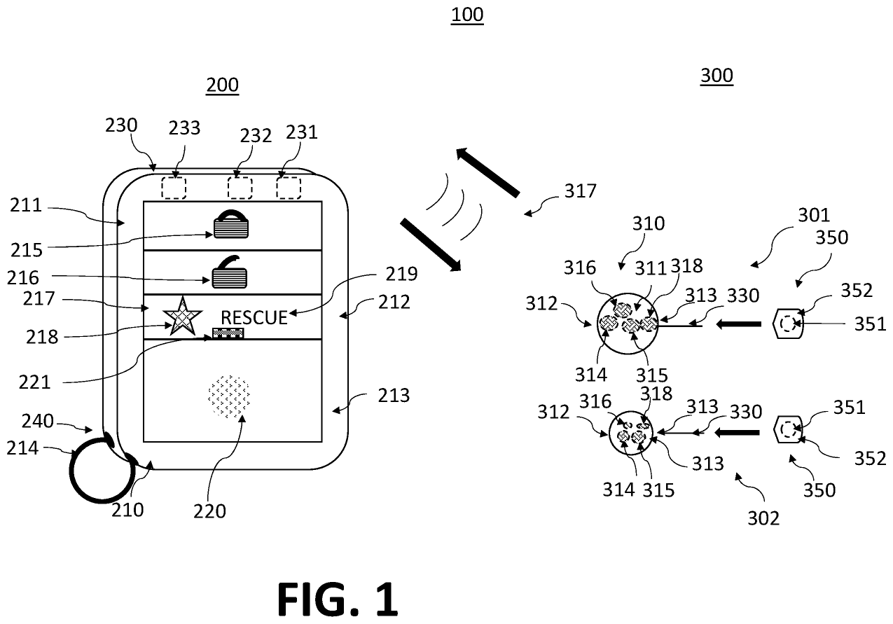

Referring to FIG. 1, an illustrated view of a personal tracking system 100 for tracking the location of a person is presented. The personal tracking system 100 cannot be easily removed, lost or stolen. The personal tracking system 100 can be worn at all times, in bed, in the shower, jogging, playing, working, etc. The personal tracking device 100 can be locked and unlocked remotely. The personal tracking system 100 is useful for unlimited search areas and immediate response. Further, the personal tracking system 100 is useful in bringing peace and mind to parents, care-givers and loved ones. Also, the personal tracking system 100 can be easily moved from one location to another location while not being detected by others.

The personal tracking system 100 has a remote control 200 and one or more earrings 300. The one or more earrings 300 are preferably adult size earrings 301, however the one or more earrings 300 may be sized to fit the ears of children 302. The earrings 300 are preferably made of surgical steel material. The steel material is preferably plated with of a white-gold- or yellow-gold.

The one or more earrings 300 has an orb 310, a stud 330 and a backing 350. The backing 350 is a locking backing. The orb 310 has an inside 311, a first end 312 and a back end 313. The inside 311 of the orb 310 of the earring 300 has a global positioning system (GPS) transceiver 314, a computing device 315 and a wireless transceiver 316. The GPS transceiver 314 receives and transmits signals to a satellite used for GPS determination, though the GPS coordinates may be by utilizing triangulation of cell sites.

The computing device 315 receives signals from the GPS transceiver 314 and translates and computes coordinates of the earring 300. The computing device 315 further can send the information to a remote control 200 by wireless signaling 317 through a wireless transceiver 316. The computing device 315, wireless transceiver 316 and GPS transceiver 314 are coupled to a power supply 318. The power supply 318 is preferably a lithium battery, however other types of power supplies are hereby contemplated, including, but not limited to, NICAD, disposable batteries, solar power, etc. The wireless signaling 317 is preferably compliant with wireless standards, such as 3GPP, 3GPP2, UMTS, 5G, proprietary signaling, etc.

The backing 350 is removable and securely coupled to the stud 330. The stud 330 is coupled to the back end 313 of the orb 310 of the earring 300. The computing device 315 of the inside 311 of the orb 310 controls the locking and unlocking of the backing 350 by sending messaging to a locking mechanism 351 on an inside 352 of the backing 350.

The remote control 200 preferably has a height of six and two-tenths centimeters (6.2 cm), however other heights are hereby contemplated, including, but not limited to, six centimeters (6 cm), six and one-half centimeters (6.5 cm), etc. The remote control 200 preferably has a width of three and one-half centimeters (3.5 cm), however other widths are hereby contemplated, including, but not limited to, three centimeters (3 cm), four centimeters (4 cm), etc. The remote control 200 preferably has a depth of two centimeters (2 cm), however other depths are hereby contemplated, including, but not limited to, one and one-half centimeters (1.5 cm), two and one-fourth centimeters (2.25 cm), etc. The remote control 200 is preferably made of a plastic material, however other materials are hereby contemplated, including, but not limited to, poly-vinyl chloride (PVC), high-density poly-ethylene (HDPE), etc.

The remote control 200 has a front 210 and an inside 230. The front 210 of the remote control 200 has a top portion 211, a middle portion 212 and a bottom portion 213. The bottom portion 213 has a ring 214, the ring 214 is useful for connecting the remote control 200 to a belt loop, hook, etc. for safe keeping and freedom of a person's hands. The ring 214 configured to be coupled to a left side 240 of the bottom 213 of the remote control 200.

The inside 230 of the remote control 200 has a wireless transceiver 231, a computing device 232 and a power supply 233. The power supply 233 is coupled to the wireless transceiver 231 and the computing device 232. The power supply 233 is preferably a lithium battery, however other types of power supplies are hereby contemplated, including, but not limited to, NICAD, disposable batteries, solar power, etc. The wireless transceiver 231 sends and receives wireless signaling 317. The wireless signaling 317 is preferably compliant with wireless standards, such as 3GPP, 3GPP2, UMTS, 5G, proprietary signaling, etc.

The top portion 211 of the front 210 of the remote control 200 has a lock button 215 and an unlock button 216. When the lock button 215 is actuated, a signal is sent to the computing device 232. The computing device 232 determines that the signal requires the lock of the backing 350 of the earring 300 shall be engaged and lock the earring 300. The computing device 232 sends a signal to the wireless transceiver 231 to send a message over the wireless signal 317 to the earring 300 to lock the backing 350 onto the stud 330 of the earring 300.

Similarly, when the unlock button 216 is actuated, a signal is sent to the computing device 232. The computing device 232 determines that the signal requires the lock of the backing 350 of the earring 300 shall be disengaged and unlock the earring 300. The computing device 232 sends a signal to the wireless transceiver 231 to send a message over the wireless signal 317 to the earring 300 to unlock the backing 350 from the stud 330 of the earring 300 and thus the backing 350 can be decoupled from the stud 330 and the earring 300 can be removed.

Further, the remote control 200 has a rescue button 217. The rescue button 217 preferably has a star symbol 218 and a writing, such as “RESCUE” 219, however other symbols or writings are hereby contemplated to convey the same information to a user. A locking tab 221 is coupled to the front 210 of the remote control 200. The locking tab 221 is preferably recessed. The locking tab 221 is useful for locking the rescue button 217 in a current condition.

When the rescue button 217 is pressed or actuated, a signal indicating the desire to actuate a location finding of a person or child. The signal is communicated to the computing device 232 of the remote control 200. The computing device 232 determines that the signal requires a finding of the earring 300 and thus the person or child wearing the earring 300. The computing device 232 sends a signal to the wireless transceiver 231 to send a wireless signal 317 to the earring 300. The wireless transceiver 316 which in turns communicates via signaling to the computing device 315 of the earring 300 to obtain GPS coordinates from the earring 300. The computing device 315 relays the GPS coordinates, continually or in predetermined intervals, to the wireless transceiver 316 to transmit the GPS coordinates, obtained from the GPS transceiver 314 of the earring 300, to the remote control 200. The rescue button 217 will activate a person to come and ask the user what the emergency is and to calm the user and call authorities, while accessing a GPS system, such as is accessed by ON-STAR®.

The wireless transceiver 216 receives the wireless signal 317 from the earring 300 and forwards the signal to the computing device 232 of the remote control 200. The computing device 232 calculates a positioning of the earring 300 and conveys the information to a user by alerting the user by a sound or converting the coordinates to speech. The sound or speech is sent to a speaker 220 configured at the bottom portion 213 of the front 210 of the remote control 200. When the person or child has been located and recovered, the rescue button 217 is again actuated or pressed to disengage the locating of the earring 300 and the personal tracking device 100 is turned off.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A personal tracking system for tracking the location of a person, the personal tracking system comprising:
one or more earrings, the earrings comprising:
an orb, the orb having a first end, a back end and an inside;
a computing device coupled to the inside of the orb;
a wireless transceiver, the wireless transceiver coupled to the inside of the orb, wherein the wireless transceiver being communicatively coupled to the computing device, and wherein the wireless transceiver being for sending and receiving wireless signaling;
a power supply, the power supply being electrically coupled to the computing device, and the power supply being electrically coupled to the wireless transceiver; and
a global positioning system (GPS) transceiver, wherein the GPS transceiver being communicatively coupled to the computing device, and wherein the GPS transceiver being electrically coupled to the power supply; and
a stud, the stud being coupled to the back end of the orb;
a backing, the backing having an inside, wherein the backing being removably and lockably coupled to the stud;
a locking mechanism coupled to an inside of the backing, wherein the locking mechanism being communicatively coupled to the computing device of the inside of the orb;
a remote control, the remote control comprising:
a front;
an inside;
a computing device coupled to the inside of the remote control;
a wireless transceiver, the wireless transceiver coupled to the inside of the remote control, wherein the wireless transceiver being communicatively coupled to the computing device, and wherein the wireless transceiver being for sending and receiving wireless signaling;
a power supply, the power supply being electrically coupled to the computing device, and the power supply being electrically coupled to the wireless transceiver;
a locking button, the locking button being configured on a top portion of the front of the remote control, and wherein the locking button being communicative coupled to the computing device;
an unlocking button, the unlocking button being configured on a top portion of the front of the remote control and wherein the unlocking button being communicative coupled to the computing device;
a rescue button, the rescue button being configured on a middle portion of the front of the remote control and wherein the rescue button being communicative coupled to the computing device;
a locking tab, the locking tab configured to be co-located with the rescue button, wherein the locking tab being for locking the rescue button in a current condition; and
a speaker, the speaker being communicatively coupled to the computing device, wherein the computing device sends a control message to activate the speaker.

2. The personal tracking system of claim 1, wherein the remote control having a length being six and two-tenths centimeters (6.2 cm).

3. The personal tracking system of claim 1, wherein the remote control having a width being three and one-half centimeters (3.5 cm).

4. The personal tracking system of claim 1, wherein the remote control having a depth being two centimeters (2 cm).

5. The personal tracking system of claim 1, wherein the remote control being made of a plastic material.

6. The personal tracking system of claim 1, wherein the power supply of the remote control being a lithium battery.

7. The personal tracking system of claim 1, wherein the power supply of the orb being a lithium battery.

8. The personal tracking system of claim 1, wherein the wireless signaling of the wireless transceiver of the orb being consistent with 5G standards.

9. The personal tracking system of claim 1, wherein the wireless signaling of the wireless transceiver of the remote control being consistent with 5G standards.

10. The personal tracking system of claim 1, wherein the earrings being made of a surgical steel material.

11. The personal tracking system of claim 10, wherein the metal material being white-gold plated.

12. The personal tracking system of claim 10, wherein the metal material being yellow-gold plated.

13. The personal tracking system of claim 1, wherein the earrings being sized to fit a child's ear.

14. The personal tracking system of claim 1, wherein the earrings being sized to fit an adult's ear.

15. The personal tracking system of claim 1, further comprising a ring, the ring being configured to be coupled to a left side of a bottom portion of the remote control.
